(19) United States
(12) Patent Application Publication
(10) Pub. No.: US 2009/0100236 A1
(43) Pub. Date: Apr. 16, 2009

(54) COPYING DATA ONTO A SECONDARY STORAGE DEVICE

(76) Inventor: RICARDO SPENCER PUIG, Round Rock, TX (US)

Correspondence Address: IBM CORP (YA);C/O YEE & ASSOCIATES PC, P.O. BOX 802333, DALLAS, TX, 75380, US

(21) Appl. No.: 11/872,391

(22) Filed: Oct. 15, 2007

(51) Int. Cl. G06F 12/16; G06F 12/14

(52) U.S. Cl. 711/162; 711/163; 711/E12.091; 711/E12.103

(57) ABSTRACT

The illustrative embodiments described herein provide an apparatus for copying data onto a secondary storage device. In one embodiment, a process identifies data associated with a data processing system to form a first set of data. The first set of data is stored on a primary storage device. The process copies the first set of data from the primary storage device to the secondary storage device to form a second set of data. The process also restricts an operating system in the data processing system from accessing the secondary storage device.

### CROSS-REFERENCE TO RELATED APPLICATION

The present invention is related to the application entitled Method for Copying Data onto a Secondary Storage Device, application Ser. No. ______, Attorney Docket Number AUS920070525US2, assigned to a common assignee, and which is incorporated herein by reference and filed concurrently herewith.

### BACKGROUND OF THE INVENTION

1. Field of the Invention

The present invention relates generally to a data processing system and in particular to an apparatus for copying data. More particularly, the present invention is directed to an apparatus and computer-usable program code for copying data onto a secondary storage device.

2. Description of the Related Art

Modern data processing systems must be able to withstand disasters that can lead to the loss of critical data, such as critical files and data associated with an operating system. Examples of disasters that may lead to the loss of data in a data processing system include human error, natural disasters, fire, power failure, terrorist attacks, organized or deliberate disruptions, theft, system and equipment failures, computer viruses, legal issues, and computer testing.

The inability of an individual or organization to recover data lost in a disaster can lead to a wide spectrum of adverse consequences ranging from financial and efficiency loss to total organizational failure. Furthermore, data recovery should occur in a time and labor efficient manner to minimize the impact of a disaster on an individual or organization. Many modern data processing systems protect against data loss from disasters by creating a backup copy of data on a storage device. The backup copy of data may then be used to restore the data processing system to a pre-disaster state.

One current method for backing up data in a data processing system uses magnetic tape to create a backup copy of data in the data processing system. However, because magnetic tape is a sequential access medium that requires rewinding and forwarding to access particular data, the amount of time required to access data on the magnetic tape can be lengthy. Hence, the amount of time required to restore the data processing system to an original state is unacceptably long. Also, due to a decrease in the cost of other types of storage media, magnetic tape no longer has a significant price advantage over storage media with faster access times.

Another current method for backing up data in a data processing system uses a process called mirroring to create at least two real-time exact copies of data on the data processing system. However, because mirroring maintains multiple exact copies of the same data set in real-time, any errors, such as software corruption or accidentally deleted files, in one copy of the data in a mirrored storage device is also present in another copy of the data in another mirrored storage device. Thus, each copy of data in each mirrored storage device contains the same errors as one another, preventing the use of any one of the data copies to restore the data processing system to an original state. For this reason, the usefulness of mirroring is limited primarily to protecting against hardware errors, and does little to protect against corruption of software components, such as operating systems components.

Another current method for protecting against data loss clones a disk, such as a hard disk, in the data processing system. An example of a disk cloning method includes the alt_disk_clone process in Advanced Interactive executive (AIX), which is available from International Business Machines Corporation. For example, an exact image of the data on a hard disk in a data processing system may be copied onto another hard disk to form a disk clone. The disk clone may then be used to restore the data processing system to an original state.

However, because disk cloning allows an operating system on the data processing system to have access to the backup storage device, errors in the data processing system may be spread to the backup storage device. For example, a bug in the operating system, a virus, or a user error, such as the accidental deletion of a file, would be replicated in the backup storage device that is accessible to the operating system. Disk cloning programs currently do not restrict or prohibit an operating system's access to the backup storage device. Also, many disk cloning processes, such as alt_disk_clone for AIX, are specific to particular operating systems and may not be compatible with all of the different operating systems available for data processing systems.

Another current method for backing up data in a data processing system creates a backup image of a disk over a network. However, similar to the method of using a magnetic tape to backup data, network backup imaging can require excessive amounts of time to restore the data processing system to an original, pre-disaster state. For example, the speed of recovery when using network backup imaging is limited to the bandwidth available over the network that is used to connect the backup storage device to the data processing system.

Another current method for backing up data in a data processing system creates a backup image of a disk on a local disk on the data processing system. However, because an operating system on the data processing system has access to the local disk, errors in the data processing system, such as bugs and user errors, may be spread to the backup storage device.

### SUMMARY OF THE INVENTION

The illustrative embodiments described herein provide an apparatus for copying data onto a secondary storage device. In one embodiment, a process identifies data associated with a data processing system to form a first set of data. The first set of data is stored on a primary storage device. The process copies the first set of data from the primary storage device to the secondary storage device to form a second set of data. The process also restricts an operating system in the data processing system from accessing the secondary storage device. In an alternative embodiment, the process that restricts an operating system in the data processing system from accessing the secondary storage device also prevents the operating system from detecting a presence of the secondary storage device. In another alternative embodiment, the process that restricts an operating system in the data processing system from accessing the secondary storage device also prohibits the operating system from accessing the secondary storage device. The secondary storage device may be connected to the primary storage device via a network.

In another embodiment, the process copies the first set of data from the primary storage device to the secondary storage device to form a second set of data in response to successfully booting the data processing system. In another embodiment, the process copies the first set of data from the primary storage device to the secondary storage device to form a second set of data on a periodic basis.

In another embodiment, the first set of data is composed of a plurality of bits. In this embodiment, the process that copies the first set of data from the primary storage device to the secondary storage device to form a second set of data copies each bit in the plurality of bits to the secondary storage device.

In an alternative embodiment, the second set of data is an identical copy of the first set of data. In another embodiment, the process that identifies data associated with a data processing system to form a first set of data, copies the first set of data from the primary storage device to the secondary storage device to form a second set of data, and restricts an operating system in the data processing system from accessing the secondary storage device is performed by firmware.

In another illustrative embodiment, an apparatus is provided for copying an operating system image onto a secondary storage device. The process identifies data associated with an operating system in a data processing system to form a first operating system image. The first operating system image is stored on a primary storage device. The process copies the first operating system image from the primary storage device to the secondary storage device to form a second operating system image. The process also restricts the operating system from accessing the secondary storage device. In one embodiment, the process also boots the data processing system using the second operating system image.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented;

FIG. 2 is a block diagram of a data processing system in which the illustrative embodiments may be implemented;

FIG. 3 is a block diagram of a system for copying data onto a secondary storage device in accordance with an illustrative embodiment;

FIG. 4 is a flowchart illustrating a process for copying data onto a secondary storage device in accordance with an illustrative embodiment; and

FIG. 5 is a flowchart illustrating a process for copying data onto a secondary storage device in accordance with an illustrative embodiment.

### DETAILED DESCRIPTION OF THE PREFERRED EMBODIMENT

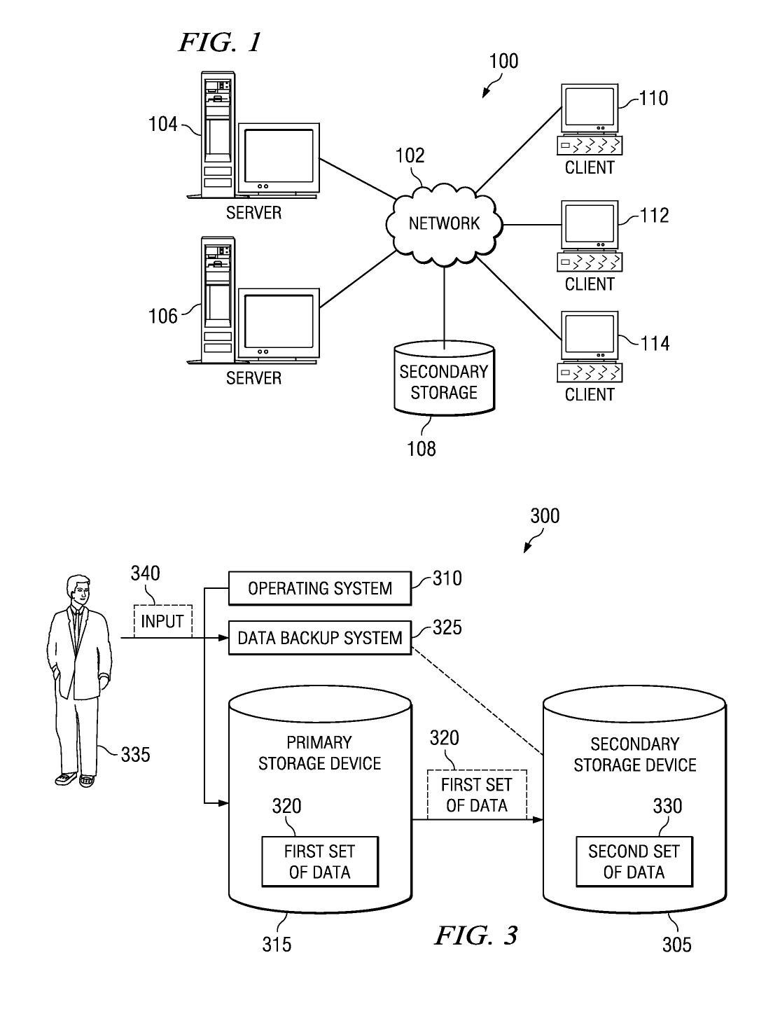

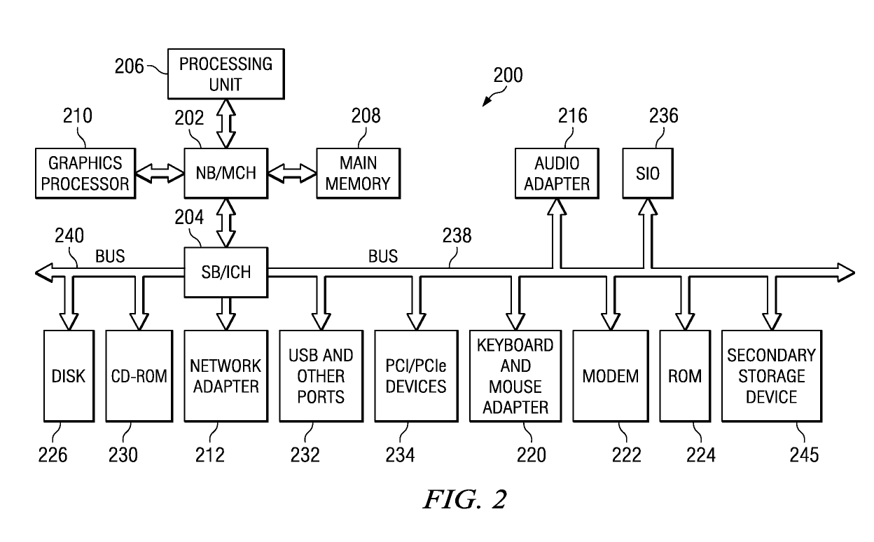

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with secondary storage device 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

Secondary storage device 108 may contain copies of data stored on servers 104 and 106 and clients 110, 112, and 114. For example, secondary storage device 108 may contain backup copies of the operating system images on servers 104 and 106 and clients 110, 112, and 114. A copy of the data of which the operating system images are composed may be transmitted over network 102. The backup copies of data stored on secondary storage device 108 may be used to restore servers 104 and 106 and clients 110, 112, and 114 to an original state in the event of data loss on network data processing system 100. Although FIG. 1 shows a single secondary storage device 108, network data processing system 100 may contain any number of secondary storage devices.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer-usable program code or instructions implementing the processes may be located for the illustrative embodiments.

In the depicted example, data processing system 200 employs a hub architecture including interface and memory controller hub (interface/MCH) 202 and interface and input/output (I/O) controller hub (interface/ICH) 204. Processing unit 206, main memory 208, and graphics processor 210 are coupled to interface and memory controller hub 202. Processing unit 206 may contain one or more processors and even may be implemented using one or more heterogeneous processor systems. Graphics processor 210 may be coupled to the interface/MCH through an accelerated graphics port (AGP), for example.

In the depicted example, local area network (LAN) adapter 212 is coupled to interface and I/O controller hub 204 and audio adapter 216, keyboard and mouse adapter 220, modem 222, read only memory (ROM) 224, universal serial bus (USB) and other ports 232, and PCI/PCIe devices 234 are coupled to interface and I/O controller hub 204 through bus 238, and hard disk drive (HDD) 226 and CD-ROM 230 are coupled to interface and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to interface and I/O controller hub 204.

An operating system runs on processing unit 206 and coordinates and provides control of various components within data processing system 200 in FIG. 2. The operating system may be a commercially available operating system such as Microsoft® Windows Vista™ (Microsoft and Windows Vista are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

A copy of any data contained in data processing system 200, such as data stored on hard disk drive 226, main memory 208, and ROM 224, may be stored on secondary storage device 245. For example, a backup copy of an operating system image stored on hard disk drive 226 may be stored on secondary storage device 245. In addition, data processing system 200 may contain software or firmware that restricts the operating system running on processing unit 206 from accessing secondary storage device 245. Firmware is “software” stored in a memory chip that holds its content without electrical power, such as, for example, read-only memory (ROM), programmable ROM (PROM), erasable programmable ROM (EPROM), electrically erasable programmable ROM (EEPROM), and nonvolatile random access memory (nonvolatile RAM).

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, ROM 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course, the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in interface and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The illustrative embodiments described herein provide an apparatus and computer-usable program code for copying data onto a secondary storage device. In one embodiment, a process identifies data associated with a data processing system to form a first set of data. The first set of data is stored on a primary storage device. Non-limiting examples of data that may be included in the first set of data include operating system images, files, programs, libraries, system settings, partition information, or any data that is stored on a storage device in the data processing system.

The process copies the first set of data from the primary storage device to the secondary storage device to form a second set of data. The secondary storage device is any storage device capable of storing the first set of data. The secondary storage device may be connected to the data processing system via any connection that permits the transfer of data, such as via a network, a universal serial bus connection, or peripheral component interconnect.

The process also restricts an operating system in the data processing system from accessing the secondary storage device. In an alternative embodiment, the process that restricts an operating system in the data processing system from accessing the secondary storage device also prevents the operating system from detecting a presence of the secondary storage device. In another alternative embodiment, the process that restricts an operating system in the data processing system from accessing the secondary storage device also prohibits the operating system from having visibility to the secondary storage device.

In another embodiment, the process copies the first set of data from the primary storage device to the secondary storage device to form a second set of data after successfully booting the data processing system. In another embodiment, the process copies the first set of data from the primary storage device to the secondary storage device to form a second set of data on a periodic basis.

In an alternative embodiment, the second set of data is an identical copy of the first set of data. In another embodiment, the process that identifies data associated with a data processing system to form a first set of data, copies the first set of data from the primary storage device to the secondary storage device to form a second set of data, and restricts an operating system in the data processing system from accessing the secondary storage device is performed by firmware.

In another illustrative embodiment, an apparatus is provided for copying an operating system image onto a secondary storage device. The process identifies data associated with an operating system in a data processing system to form a first operating system image. The first operating system image is stored on a primary storage device. The process copies the first operating system image from the primary storage device to the secondary storage device to form a second operating system image. The process also restricts the operating system from accessing the secondary storage device. In one embodiment, the process also boots the data processing system using the second operating system image.

Turning now to FIG. 3, a block diagram of a system for copying data onto a secondary storage device is depicted in accordance with an illustrative embodiment. Specifically, FIG. 3 depicts data processing system 300, which contains components to copy data onto secondary storage device 305. Examples of data processing system 300 include network data processing system 100 in FIG. 1 and data processing system 200 in FIG. 2.

Data processing system 300 includes operating system 310. Operating system 310 manages the hardware and software resources of data processing system 300, such as primary storage device 315. Non-limiting examples of operating system 310 include Microsoft® Windows Vista™ and Advanced Interactive executive (AIX®), which is available from International Business Machines Corporation. Microsoft and Windows Vista are trademarks of Microsoft Corporation in the United States, other countries, or both. AIX is a trademark of International Business Machines Corporation in the United States, other countries, or both.

Although FIG. 3 shows only a single operating system 310, data processing system may contain any number of operating systems. For example, data processing system may be partitioned into two or more logical partitions that each contains an independent operating system that manages the hardware and software resources for the operating system's respective logical partition.

Data processing system 300 contains primary storage device 315. Primary storage device 315 is any device capable of storing data. Non-limiting examples of primary storage device 315 include a hard disk, such as hard disk drive 226 in FIG. 2, read only memory, such as ROM 224 in FIG. 2, random access memory, such as main memory 208 in FIG. 2, flash memory, a detachable storage disk, and an optical disk. Primary storage device 315 may also be connected to data processing system 300 over a network, such as network 102 in FIG. 1. Although FIG. 3 depicts a single primary storage device 315, data processing system 300 may contain any number of primary storage devices.

Primary storage device 315 contains first set of data 320. First set of data is any data associated with data processing system 300. First set of data includes one or more bits of data. Non-limiting examples of data that may be included in first set of data 320 include files, programs, libraries, system settings, partition information, or any other data that is stored on primary storage device 315.

In one embodiment, first set of data 320 is a first operating system image. In this embodiment, the first operating system image is an image of operating system 310 and contains data associated with operating system 310. In one embodiment, the first operating system image is an instance of operating system 310 that may be used to manage the resources of data processing system 300. For example, the first operating system image may contain the data structure and data content of an instance of operating system 310. Non-limiting examples of data that may be included in the first operating system image include library files, such as dynamically linked library files, boot sector data, device drivers, system settings, development tools, programs, partition information, or any other data associated with operating system 310.

Although data processing system 300 contains a single operating system 310, a single data backup system 325, and a single first set of data 320, in one embodiment, an initial configuration of data processing system 300 includes at least two separate, distinct, and substantially identical images of each of operating system 310, data backup system 325, and first set of data 320. Each of these separate, distinct, and substantially identical images may reside on separate and distinct storage devices in data processing system 300. By including separate and distinct copies of each of operating system 310, data backup system 325, and first set of data 320 on data processing system 300, an additional layer of redundancy is achieved in case of a disaster.

Data processing system 300 also includes secondary storage device 305. Secondary storage device 305 is any device capable of storing data. Non-limiting examples of secondary storage device 305 include secondary storage device 108 in FIG. 1, secondary storage device 245 in FIG. 2, random access memory, such as main memory 208 in FIG. 2, flash memory, an external hard drive, an optical disk, or a pocket hard drive. In one embodiment, secondary storage device 305 has a data access time that is equal to or faster than the access time to operating system 310 to lessen any degradation in recovery time.

In another embodiment, data processing system 300 includes multiple secondary storage devices that are each used to store copies of either operating system images or data that is not included in an operating system image. For example, assuming that data processing system 300 includes two secondary storage devices, one of the secondary storage device may be used to store only copies or one or more operating system images, while the other secondary storage device may be used to store only copies of data that is not included in an operating system image.

Secondary storage device 305 may be connected to data processing system 300 in a variety of ways. For example, secondary storage device 305 may be connected to data processing system 300 over a network, such as network 102 in FIG. 1. In this example, secondary storage device 305 may use internet small computer system (iSCSI) technology to communicate with data processing system 300. iSCSI is a network protocol standard that allows the use of the SCSI protocol over TCP/IP networks. In another example, secondary storage device may use fibre channel technology to communicate with data processing system 300. Fibre channel is a gigabit-speed network technology used primarily for storage networking. Using these and other networking technologies, secondary storage device 305 may be located at an off-site location that is different from the location of data processing system 300.

Also, secondary storage device 305 may be connected to data processing system 300 using any of a variety of connection types. For example, secondary storage device 305 may be connected to data processing system 300 using connections types such as USB, firewire, Peripheral Component Interconnect (PCI), optical, and Ethernet connections. Also, FIG. 3 depicts a single primary storage device 315, data processing system 300 may contain any number of primary storage devices.

Data processing system 300 includes data backup system 325. Data backup system 325 may be hardware, software, firmware, middleware, or any instructional media for instructing data processing system 300.

In one embodiment, data backup system 325 identifies data associated with data processing system 300 to form first set of data 320. First set of data is stored on primary storage device 315.

In this embodiment, data backup system 325 copies first set of data 320 from primary storage device 315 to secondary storage device 305 to form second set of data 330. In one embodiment, first set of data 320 and second set of data 330 are operating system images that include data associated with operating system 310. In one embodiment, second set of data 330 is an identical copy of first set of data 320.

In another embodiment, first set of data 320 is composed of a plurality of bits. In this embodiment, data backup system 325 copies first set of data 320 from primary storage device 315 to secondary storage device 305 to form second set of data 330 by copying each bit in the plurality of bits to secondary storage device 305. Thus, second set of data 330 may be a byte-for-byte copy of first set of data 320 that includes the structure and contents of first set of data 320. In one example, data backup system 325 may copy first set of data 320 from primary storage device 315 to secondary storage device 305 to form second set of data 330 using a ‘dd’ UNIX command.

In one embodiment, secondary storage device 305 is connected to primary storage device 315 over a network, such as network 102 in FIG. 1. Thus, data backup system 325 may copy first set of data 320 from primary storage device 315 to secondary storage device 305 over a network.

In another embodiment, data backup system 325 copies first set of data 320 from primary storage device 315 to secondary storage device 305 to form second set of data 330 in response to an event. In this example, the event is successfully booting up data processing system 300. Non-limiting examples of booting up data processing system 300 include a hard reboot, a soft reboot, or a random reboot. Copying first set of data 320 after a successful boot of data processing system 300 increases the likelihood that first set of data 320 is in a non-corrupt state at the time of being copied. In these examples, first set of data 320 may include an operating system image.

In another embodiment, data backup system 325 copies first set of data 320 from primary storage device 315 to secondary storage device 305 to form second set of data 330 in response to an event that is a periodic event. For example, data backup system 325 may copy first set of data 320 on an hourly, daily, weekly, or monthly basis. The frequency at which data backup system 325 copies first set of data 320 may be defined by user 335.

In another example, data backup system 325 copies first set of data 320 from primary storage device 315 to secondary storage device 305 to form second set of data 330 in response to input 340 from user 335. In this example, input 340 may be an indication from user 335 to create a backup copy of data on data processing system 300.

Data backup system 325 also restricts operating system 310 from accessing secondary storage device 305. In one example, data backup system 325 restricts operating system 310 from accessing secondary storage device 305 while data backup system 325 copies first set of data 320 from primary storage device 315 to secondary storage device 305 to form second set of data 330. In another example, data backup system 325 limits or prohibits read and write operations that may be performed on secondary storage device 305 by operating system 310. In another example, data backup system 325 isolates secondary storage device 305 from being accessed by operating system 310.

Data backup system 325 may restrict access to secondary storage device 305 by operating system 310 in a variety of ways. In the example in which operating system 310 is a Unix-based operating system, such as AIX, data backup system 325 may be firmware that controls a device tree associated with data processing system 300. The firmware may also control the devices that are presented to operating system 310. In this example, data backup system 325 does not present secondary storage device 305. as an allowable or visible resource to operating system 310.

Data backup system 325 may also be a modified Basic Input/Output System (BIOS) to restrict access to secondary storage device 305 by operating system 310. In this example, BIOS may shield secondary storage device 305 from being detected as a new device during boot up or when calls are made by operating system 310. BIOS may also allow data processing system 300 to be booted up using secondary storage device 305.

In another example in which data backup system 325 is software, data processing system 300 may include two operating systems. In this example, one of the operating systems may run a software version of data backup system 325 to prevent the other operating system from accessing secondary storage device 305.

In an alternate embodiment, data backup system 325 prevents operating system 310 from detecting a presence of secondary storage device 305. For example, data backup system 325 may prevent secondary storage device 305 from being visible to operating system 310. In another example, data backup system 325 may be visible to secondary storage device 305 while preventing secondary storage device 305 from being visible to operating system 310. In another embodiment, data backup system 325 prohibits operating system 310 from accessing secondary storage device 305.

Thus, by restricting operating system 310 from accessing secondary storage device 305, data backup system 325 protects secondary storage device 305 from corruption that may be caused by operating system 310. For example, data backup system 325 may protect secondary storage device 305 against user error originating from user 335. A non-limiting example of user error includes the accidental overwrite of files on secondary storage device 305. In another example, data backup system 325 protects secondary storage device 305 against bugs or viruses that may be present in data processing system 300 or operating system 310.

In one embodiment, identifying data associated with data processing system 300 to form first set of data 320, copying first set of data 320 from primary storage device 315 to secondary storage device 305 to form second set of data 330, and restricting operating system 310 from accessing secondary storage device 305 is performed by firmware. In this embodiment, these steps may be performed by firmware using firmware isolation technology.

In an alternative embodiment, data backup system 325 may copy an operating system image onto secondary storage device 305. In this embodiment, data backup system 325 identifies data associated with operating system 310 in data processing system 300 to form a first operating system image. The first operating system image is stored on primary storage device 315. Data backup system 325 copies the first operating system image from primary storage device 315 to secondary storage device 305 to form a second operating system image. Data backup system 325 also restricts operating system 310 from accessing secondary storage device 305. In one embodiment, data processing system 300 may be booted using the second operating system image.

In one embodiment, data backup system 325 copies operating system images onto a different storage device than data that is not included in operating system images. For example, data backup system 325 may copy an operating system image of operating system 310 onto secondary storage device 305 while copying a set of data is not included in the operating system image onto a storage device that is separate from secondary storage device 305.

In an alternate embodiment, data processing system 300 may be a logically partitioned data processing system. In this embodiment, each logical partition in data processing system 300 may contain a data backup system, such as data backup system 325. Alternatively, a single data backup system 325 may be used by all of the logical partitions in data processing system 300.

In the embodiment in which data processing system 300 includes a plurality of logical partitions, user 335 or data backup system 325 may select a set of operating systems in a plurality of operating systems. In this embodiment, each operating system in the plurality of operating systems corresponds to a logical partition in data processing system 300. The set of operating systems includes one or more operating systems in the plurality of operating systems. Data backup system 325 identifies data associated with the set of operating systems in the data processing system to form a first set of operating system images. Each operating system image in the first set of operating system images is stored on a set of primary storage devices. The set of primary storage devices includes one or more primary storage devices, such as primary storage device 315.

In this embodiment, data backup system 325 copies the first set of operating system images from the set of primary storage devices to a set of secondary storage devices to form a second set of operating system images. The set of secondary storage devices include one or more secondary storage devices, such as secondary storage device 305. In this embodiment, data backup system 325 also restricts the set of operating systems from accessing the set of secondary storage devices.

Data backup system 325 may be installed on data processing system 300 from a variety of sources. In one embodiment, user 335 sends a request to provide a backup service. In this embodiment, user 335 may be a customer. The set of parameters may be received by a second data processing system, such as servers 104 and 106, over a network, such as network 102 in FIG. 1. The second data processing system that receives the set of parameters may then identify parameters for data processing system 300. The second data processing system selects the data backup system using the parameters to form a selected data backup system. In one example, the selected data backup system is data backup system 325. Also, selecting the data backup system may include configuring the program code included in the selected data backup system. For example, the program code included in the selected data backup system may be configured to be compatible with data processing system 300. Data backup system 325 may be software, firmware, middleware, or any instructional media for instructing data processing system 300.

In one embodiment, the selected data backup system includes computer usable program code for copying data onto secondary storage device 305. For example, the selected data backup system may include computer-usable program code for identifying data associated with the data processing system to form first set of data 320. First set of data 320 may be stored on primary storage device 315. The selected data backup system may include computer-usable program code for copying first set of data 320 from primary storage device 315 to secondary storage device 305 to form second set of data 330. The selected data backup system may also include computer-usable program code for restricting operating system 310 in data processing system 300 from accessing secondary storage device 305.

The second data processing system that received the set of parameters may then deploy the selected data backup system onto data processing system 300. In one embodiment, deploying the selected data backup system includes transmitting the selected data backup system to data processing system 300 over a network, such as network 102 in FIG. 1. In another embodiment, deploying the selected data backup system includes installing the selected data backup system onto data processing system 300.

In another example, a billing transaction may take place between user 335 and the second data processing system that identifies the set of parameters about data processing system 300. For example, user 335 may be charged a fee for deploying or downloading the selected data backup system, such as data backup system 325, onto data processing system 300. In another example, user 335 may purchase a software package containing the selected data backup system, such as data backup system 325. In another example, user 335 may purchase a data processing system, such as data processing system 300, which comes pre-packaged or pre-installed with data backup system 325.

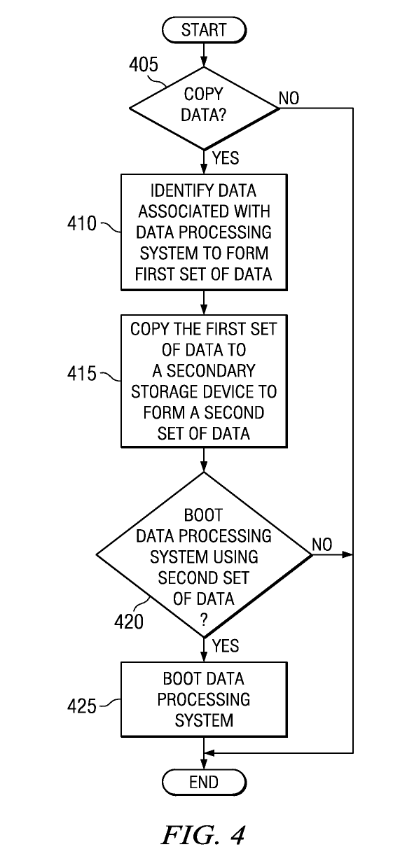

Turning now to FIG. 4, a flowchart illustrating a process for copying data onto a secondary storage device is depicted in accordance with an illustrative embodiment. The process illustrated in FIG. 4 may be implemented by data backup system, such as data backup system 325 in FIG. 3.

The process begins by determining whether to copy or backup data located on a primary storage device, such as primary storage device 315 in FIG. 3 (step 405). For example, the process may determine whether to copy or backup an operating system image located on a data processing system. If the process determines not to copy or backup data, the process terminates.

Returning to step 405, if the process determines to copy or backup data located on a primary storage device, the process identifies data associated with the data processing system to form a first set of data (step 410). The first set of data may be stored on the primary storage device. The process then copies the first set of data to a secondary storage device to form a second set of data (step 415). In one embodiment, the first set of data and the second set of data are a first operating system image and a second operating system image, respectively.

The process then determines whether to boot the data processing system using the second set of data (step 420). In one embodiment, the process determines whether to boot the data processing system using the second operating system image. In an alternate embodiment, the process determines whether to boot the data processing system using the second set of data in response to input from a user, such as user 335 in FIG. 3. If the process determines to boot the data processing system using the second set of data, the process then boots the data processing system using the second set of data (step 425). The process then terminates. Returning to step 420, if the process determines not to boot the data processing system using the second set of data, the process then terminates.

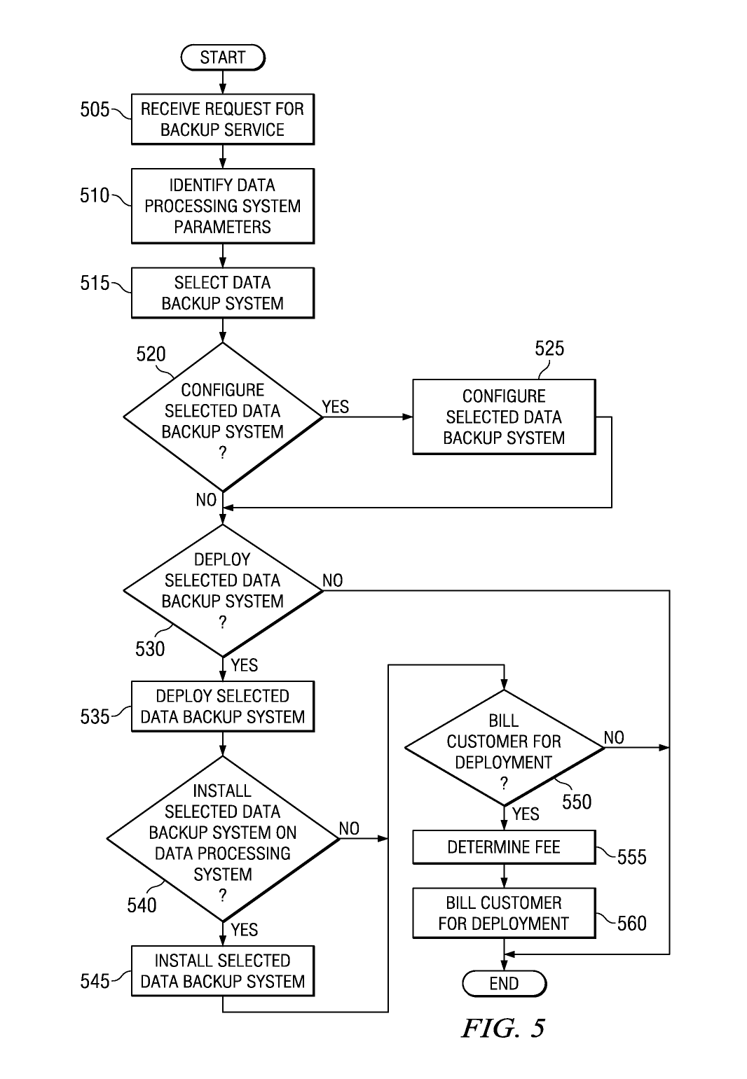

Turning now to FIG. 5, a flowchart illustrating a process for copying data onto a secondary storage device is depicted in accordance with an illustrative embodiment. The process illustrated in FIG. 5 may be implemented by a data processing system, such as servers 104 and 106 in FIG. 1.

The process begins by receiving a request to provide a backup service (step 505). The process identifies data processing system parameters for the data processing system for which the backup service is requested (step 510). The process then selects a data backup system using the data processing system parameters to form a selected data backup system (step 515).

The process determines whether to configure the selected data backup system (step 520). If the process determines to configure the selected data backup system, the process configures the selected data backup system (step 525). The process then proceeds to step 530.

If the process determines not to configure the selected data backup system, then the process determines whether to deploy the selected data backup system (step 530). If the process determines not to deploy the selected data backup system, then the process terminates. If the process determines to deploy the selected data backup system, then the process deploys the selected data backup system onto the data processing system (step 535).

The process determines whether to install the selected data backup system onto the data processing system (step 540). If the process determines not to install the selected data backup system onto the data processing system, then the process proceeds to step 550. If the process determines to install the selected data backup system onto the data processing system, then the process installs the selected data backup system (step 540).

The process determines whether to bill a customer for deploying the selected data backup system (step 550). If the process determines not to bill a customer for deploying the selected data backup system, the process terminates. If the process determines to bill a customer for deploying the selected data backup system, then the process determines a fee (step 555). The process then bills the customer for deploying the selected data backup system (step 560). The process then terminates.

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

The illustrative embodiments described herein provide an apparatus for copying data onto a secondary storage device. In one embodiment, a process identifies data associated with a data processing system to form a first set of data. The first set of data is stored on a primary storage device.

The process copies the first set of data from the primary storage device to the secondary storage device to form a second set of data. The secondary storage device is any storage device capable of storing the first set of data.

The process also restricts an operating system in the data processing system from accessing the secondary storage device. In an alternative embodiment, the process that restricts an operating system in the data processing system from accessing the secondary storage device also prevents the operating system from detecting a presence of the secondary storage device. In another alternative embodiment, the process that restricts an operating system in the data processing system from accessing the secondary storage device also prohibits the operating system from accessing the secondary storage device.

In another embodiment, the process copies the first set of data from the primary storage device to the secondary storage device to form a second set of data in response to booting the data processing system. In another embodiment, the process copies the first set of data from the primary storage device to the secondary storage device to form a second set of data on a periodic basis.

In an alternative embodiment, the second set of data is an identical copy of the first set of data. In another embodiment, the process that identifies data associated with a data processing system to form a first set of data, copies the first set of data from the primary storage device to the secondary storage device to form a second set of data, and restricts an operating system in the data processing system from accessing the secondary storage device is performed by firmware.

In another illustrative embodiment, an apparatus is provided for copying an operating system image onto a secondary storage device. The process identifies data associated with an operating system in a data processing system to form a first operating system image. The first operating system image is stored on a primary storage device. The process copies the first operating system image from the primary storage device to the secondary storage device to form a second operating system image. The process also restricts the operating system from accessing the secondary storage device. In one embodiment, the process also boots the data processing system using the second operating system image.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Further, a computer storage medium may contain or store a computer readable program code such that when the computer readable program code is executed on a computer, the execution of this computer readable program code causes the computer to transmit another computer readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer program product comprising:
a computer-usable medium having computer-usable program code for copying data onto a secondary storage device, the computer program product comprising:
computer-usable program code for identifying data associated with a data processing system to form a first set of data, wherein the first set of data is stored on a primary storage device;
computer-usable program code for copying the first set of data from the primary storage device to the secondary storage device to form a second set of data; and
computer-usable program code for restricting an operating system in the data processing system from accessing the secondary storage device.

2. The computer program product of claim 1, wherein the computer-usable program code for restricting the operating system in the data processing system from accessing the secondary storage device further comprises:
computer-usable program code for preventing the operating system from detecting a presence of the secondary storage device.

3. The computer program product of claim 1, wherein the computer-usable program code for restricting the operating system in the data processing system from accessing the secondary storage device further comprises:
computer-usable program code for prohibiting the operating system from accessing the secondary storage device.

4. The computer program product of claim 1, wherein the computer-usable program code for copying the first set of data from the primary storage device to the secondary storage device to form the second set of data is executed in response to successfully booting the data processing system.

5. The computer program product of claim 1, wherein the computer-usable program code for copying the first set of data from the primary storage device to the secondary storage device to form the second set of data is executed on a periodic basis.

6. The computer program product of claim 1, wherein the secondary storage device is connected to the primary storage device via a network.

7. The computer program product of claim 1, wherein the first set of data is composed of a plurality of bits, and wherein the computer-usable program code for copying the first set of data from the primary storage device to the secondary storage device to form the second set of data further comprises:
computer-usable program code for copying each bit in the plurality of bits to the secondary storage device.

8. The computer program product of claim 1, wherein the second set of data is an identical copy of the first set of data.

9. The computer program product of claim 1, wherein the computer-usable program code for identifying data associated with the data processing system to form the first set of data, the computer-usable program code for copying the first set of data from the primary storage device to the secondary storage device to form the second set of data, and the computer-usable program code for restricting the operating system in the data processing system from accessing the secondary storage device is performed by firmware.

10. The computer program product of claim 1, wherein the first set of data is a first operating system image, wherein the second set of data is a second operating system image, and wherein the first operating system image and the second operating system image include data associated with the operating system.

11. A computer program product comprising:
a computer-usable medium having computer-usable program code for deploying a data backup system, the computer program product comprising:
computer-usable program code for receiving a request to provide a backup service;
computer-usable program code for identifying parameters for a data processing system on which the backup service is requested;
computer-usable program code for selecting the data backup system using the parameters to form a selected data backup system;
computer-usable program code for deploying the selected data backup system onto the data processing system, wherein the selected data backup system comprises deployable computer-usable program code for copying data onto a secondary storage device, and wherein the deployable computer-usable program code comprises:
computer-usable program code for identifying data associated with the data processing system to form a first set of data, wherein the first set of data is stored on a primary storage device;
computer-usable program code for copying the first set of data from the primary storage device to the secondary storage device to form a second set of data; and
computer-usable program code for restricting an operating system in the data processing system from accessing the secondary storage device.

12. The computer program product of claim 11, wherein the computer-usable program code for deploying the selected data backup system onto the data processing system comprises:
computer-usable program code for transmitting the selected data backup system to the data processing system over a network.

13. The computer program product of claim 11, wherein the computer-usable program code for deploying the selected data backup system onto the data processing system comprises:
computer-usable program code for installing the selected data backup system onto the data processing system.

14. The computer program product of claim 11, further comprising:
computer-usable program code for billing a customer for deploying the selected data backup system.

15. The computer program product of claim 11, wherein the computer-usable program code for selecting the data backup system using the parameters to form the selected data backup system further comprises:
computer-usable program code for configuring the deployable computer-usable program code.

16. The computer program product of claim 11, wherein the selected data backup system is firmware.

17. A data processing system comprising:
a bus system;
a memory connected to the bus system, wherein the memory includes a set of instructions; and
a processing unit connected to the bus system, wherein the processing unit executes the set of instructions to identify data associated with a data processing system to form a first set of data, wherein the first set of data is stored on a primary storage device; copy the first set of data from the primary storage device to the secondary storage device to form a second set of data; and restrict an operating system in the data processing system from accessing the secondary storage device.

18. The data processing system of claim 17, wherein in executing the set of instructions to restrict the operating system in the data processing system from accessing the secondary storage device, the processing unit further executes the set of instructions to prevent the operating system from detecting a presence of the secondary storage device.

19. The data processing system of claim 17, wherein in executing the set of instructions to restrict the operating system in the data processing system from accessing the secondary storage device, the processing unit further executes the set of instructions to prohibit the operating system from accessing the secondary storage device.

20. The data processing system of claim 17, wherein the set of instructions to copy the first set of data from the primary storage device to the secondary storage device to form the second set of data is executed in response to successfully booting the data processing system.

21. The data processing system of claim 17, wherein the second set of data is an identical copy of the first set of data.

22. The data processing system of claim 17, wherein the set of instructions are contained in firmware.

23. A computer program product comprising:
a computer-usable medium having computer-usable program code for copying an operating system image onto a secondary storage device, the computer program product comprising:
computer-usable program code for identifying data associated with an operating system in a data processing system to form a first operating system image, wherein the first operating system image is stored on a primary storage device;
computer-usable program code for copying the first operating system image from the primary storage device to the secondary storage device to form a second operating system image; and
computer-usable program code for restricting the operating system from accessing the secondary storage device.

24. The computer program product of claim 23, wherein the computer-usable program code for restricting the operating system in the data processing system from accessing the secondary storage device further comprises:
computer-usable program code for preventing the operating system from detecting a presence of the secondary storage device.

25. The computer program product of claim 23, wherein the computer-usable program code for restricting the operating system in the data processing system from accessing the secondary storage device further comprises:
computer-usable program code for prohibiting the operating system from accessing the secondary storage device.

26. The computer program product of claim 23, wherein the first operating system image is composed of a plurality of bits, and wherein the computer-usable program code for copying the first operating system image from the primary storage device to the secondary storage device to form a second operating system image further comprises:
computer-usable program code for copying each bit in the plurality of bits to the secondary storage device.

27. The computer program product of claim 23, further comprising:
computer-usable program code for booting the data processing system using the second operating system image.

28. The computer program product of claim 23, wherein the computer-usable program code for identifying data associated with the operating system in the data processing system to form the first operating system image, the computer-usable program code for copying the first operating system image from the primary storage device to the secondary storage device to form the second operating system image, and the computer-usable program code for restricting the operating system from accessing the secondary storage device are performed by firmware.

29. A computer program product comprising:
a computer-usable medium having computer-usable program code for copying an operating system image onto a secondary storage device, the computer program product comprising:
computer-usable program code for identifying data associated with an operating system in a data processing system to form a first operating system image, wherein the first operating system image is stored on a primary storage device, and wherein the first operating system image is composed of a plurality of bits;
computer-usable program code for copying the first operating system image from the primary storage device to the secondary storage device to form a second operating system image, wherein the second operating system image is an identical copy of the first operating system image, and wherein each bit in the plurality of bits is copied to the secondary storage device; and
computer-usable program code for prohibiting the operating system from accessing the secondary storage device, wherein the computer-usable program code for identifying data associated with the operating system in the data processing system to form the first operating system image, the computer-usable program code for copying the first operating system image from the primary storage device to the secondary storage device to form the second operating system image, and the computer-usable program code for prohibiting the operating system from accessing the secondary storage device are performed by firmware located on the data processing system.
